(19) United States
(12) Patent Application Publication
(10) Pub. No.: US 2026/0135603 A1
(43) Pub. Date: May 14, 2026

(54) USE OF REDUCED DIMENSIONAL ADAPTIVE BEAM WEIGHTS FOR UPLINK TRANSMISSION

(71) Applicant: QUALCOMM Incorporated, San Diego, CA (US)

(72) Inventors: Vasanthan RAGHAVAN, West Windsor Township, NJ (US); Junyi LI, Greentown, PA (US)

(21) Appl. No.: 18/942,236

(22) Filed: Nov. 8, 2024

(51) Int. Cl. H04B 7/06; H04L 5/00

(52) U.S. Cl. CPC H04B 7/06952; H04B 7/0617; H04L 5/0051

(57) ABSTRACT

Methods, systems, and devices for wireless communications are described. A first wireless communication device (e.g., a user equipment (UE)) may transmit sounding reference signals (SRSs) via a set of beams via application of adaptive beam weights using a subset of the total quantity of antenna elements of the first wireless communication device. Accordingly, the first wireless communication device may perform adaptive beam training, but may reduce the total quantity of possible adaptive beam weights. The first wireless communication device may request SRS resources from the second wireless communication device (e.g., a network entity) and the second wireless communication device may grant SRS resources for the first wireless communication device to perform the adaptive beam training. The second wireless communication device may measure the SRSs and may estimate the set of adaptive beam weights for the first wireless communication device to use for a subsequent uplink communication.

### FIELD OF TECHNOLOGY

The following relates to wireless communications, including use of reduced dimensional adaptive beam weights, for example, that are not stored within the radio frequency integrated circuit (RFIC) chip memory, for uplink transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first wireless communication device is described. The method may include transmitting, to a second wireless communication device, a request for a quantity of sounding reference signal (SRS) opportunities to perform adaptive uplink beam training for millimeter (mm) wave communications between the first wireless communication device and the second wireless communication device, where the quantity of SRS opportunities is based on a parameter for the mm wave communications, receiving, from the second wireless communication device, a grant for a set of SRS opportunities, where the set of SRS opportunities is based on the quantity requested by the first wireless communication device, and transmitting a set of SRSs via the set of SRS opportunities and using, for at least a subset of the set of SRSs, a set of beams formed by application of respective sets of adaptive beam weights to a set of antenna elements of the first wireless communication device.

A first wireless communication device for wireless communications is described. The first wireless communication device may include one or more memories storing processor executable code, and one or more processors coupled with the one or more memories. The one or more processors may individually or collectively be operable to execute the code to cause the first wireless communication device to transmit, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications, receive, from the second wireless communication device, a grant for a set of SRS opportunities, where the set of SRS opportunities is based on the quantity requested by the first wireless communication device, and transmit a set of SRSs via the set of SRS opportunities and using, for at least a subset of the set of SRSs, a set of beams formed by application of respective sets of adaptive beam weights to a set of antenna elements of the first wireless communication device.

Another first wireless communication device for wireless communications is described. The first wireless communication device may include means for transmitting, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications, means for receiving, from the second wireless communication device, a grant for a set of SRS opportunities, where the set of SRS opportunities is based on the quantity requested by the first wireless communication device, and means for transmitting a set of SRSs via the set of SRS opportunities and using, for at least a subset of the set of SRSs, a set of beams formed by application of respective sets of adaptive beam weights to a set of antenna elements of the first wireless communication device.

A non-transitory computer-readable medium storing code for wireless communications is described. The code may include instructions executable by one or more processors to transmit, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications, receive, from the second wireless communication device, a grant for a set of SRS opportunities, where the set of SRS opportunities is based on the quantity requested by the first wireless communication device, and transmit a set of SRSs via the set of SRS opportunities and using, for at least a subset of the set of SRSs, a set of beams formed by application of respective sets of adaptive beam weights to a set of antenna elements of the first wireless communication device.

Some examples of the method, first wireless communication devices, and non-transitory computer-readable medium described herein may further include operations, features, means, or instructions for receiving, from the second wireless communication device and based on transmitting the set of SRSs, an indication of a set of adaptive beam weights to apply to the set of antenna elements for an uplink communication.

Some examples of the method, first wireless communication devices, and non-transitory computer-readable medium described herein may further include operations, features, means, or instructions for performing the uplink communication via an application of the set of adaptive beam weights to apply to the set of antenna elements.

Some examples of the method, first wireless communication devices, and non-transitory computer-readable medium described herein may further include operations, features, means, or instructions for receiving, from the second wireless communication device, an indication of a quantity of antenna elements of the first wireless communication device to use for the adaptive uplink beam training, where transmission of the request may be based on the indication of the quantity of antenna elements, and where the quantity of antenna elements may be less than a total quantity of antenna elements available at the first wireless communication device.

In some examples of the method, first wireless communication devices, and non-transitory computer-readable medium described herein, transmitting the request may include operations, features, means, or instructions for transmitting an indication of a quantity of antenna elements of the first wireless communication device that the first wireless communication device may be capable of using for the adaptive uplink beam training.

In some examples of the method, first wireless communication devices, and non-transitory computer-readable medium described herein, the parameter for the mm wave communications includes a quantity of antenna elements of the first wireless communication device, a quantity of antenna elements of the first wireless communication device, an uplink link budget, a quantity of radio frequency chains at the first wireless communication device, a quantity of radio frequency chains at the second wireless communication device, or a combination thereof.

In some examples of the method, first wireless communication devices, and non-transitory computer-readable medium described herein, transmitting the set of SRSs may include operations, features, means, or instructions for using, for at least a second subset of the set of SRSs, a second set of beams via application of a set of codebook-based static beam weights to a second set of antenna elements of the first wireless communication device.

In some examples of the method, first wireless communication devices, and non-transitory computer-readable medium described herein, the set of antenna elements of the first wireless communication device may be a subset of the second set of antenna elements.

In some examples of the method, first wireless communication devices, and non-transitory computer-readable medium described herein, the respective sets of adaptive beam weights include respective phase shift values.

In some examples of the method, first wireless communication devices, and non-transitory computer-readable medium described herein, the first wireless communication device may be a user equipment (UE) and the second wireless communication device may be one of a network entity, a relay node, a repeater, or an integrated access and backhaul (IAB) node.

In some examples of the method, first wireless communication devices, and non-transitory computer-readable medium described herein, the first wireless communication device may be one of a relay node, a repeater, a customer premises equipment, or an IAB node and the second wireless communication device may be one of a network entity, a second relay node, a second repeater, or a second IAB node.

A method for wireless communications a second wireless communication device by an apparatus is described. The method may include receiving, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications, transmitting, to the first wireless communication device, a grant for a set of SRS opportunities, where the set of SRS opportunities is based on the quantity requested by the first wireless communication device, and receiving, from the first wireless communication device, a set of SRSs via the set of SRS opportunities and using, for at least a subset of the set of SRSs, a set of beams associated with respective sets of adaptive beam weights for a set of antenna elements of the first wireless communication device.

An apparatus for wireless communications a second wireless communication device is described. The apparatus may include one or more memories storing processor executable code, and one or more processors coupled with the one or more memories. The one or more processors may individually or collectively be operable to execute the code to cause the apparatus to receive, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications, transmit, to the first wireless communication device, a grant for a set of SRS opportunities, where the set of SRS opportunities is based on the quantity requested by the first wireless communication device, and receive, from the first wireless communication device, a set of SRSs via the set of SRS opportunities and using, for at least a subset of the set of SRSs, a set of beams associated with respective sets of adaptive beam weights for a set of antenna elements of the first wireless communication device.

Another apparatus for wireless communications a second wireless communication device is described. The apparatus may include means for receiving, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications, means for transmitting, to the first wireless communication device, a grant for a set of SRS opportunities, where the set of SRS opportunities is based on the quantity requested by the first wireless communication device, and means for receiving, from the first wireless communication device, a set of SRSs via the set of SRS opportunities and using, for at least a subset of the set of SRSs, a set of beams associated with respective sets of adaptive beam weights for a set of antenna elements of the first wireless communication device.

A non-transitory computer-readable medium storing code for wireless communications a second wireless communication device is described. The code may include instructions executable by one or more processors to receive, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications, transmit, to the first wireless communication device, a grant for a set of SRS opportunities, where the set of SRS opportunities is based on the quantity requested by the first wireless communication device, and receive, from the first wireless communication device, a set of SRSs via the set of SRS opportunities and using, for at least a subset of the set of SRSs, a set of beams associated with respective sets of adaptive beam weights for a set of antenna elements of the first wireless communication device.

Some examples of the method, apparatus, and non-transitory computer-readable medium described herein may further include operations, features, means, or instructions for transmitting, to the first wireless communication device and based on reception of the set of SRSs, an indication of a set of adaptive beam weights to apply to the set of antenna elements for an uplink communication.

Some examples of the method, apparatus, and non-transitory computer-readable medium described herein may further include operations, features, means, or instructions for receiving the uplink communication using a beam associated with the set of adaptive beam weights.

In some examples of the method, apparatus, and non-transitory computer-readable medium described herein, the beam may be associated with a second set of adaptive beam weights applied to a second set of antennas of the second wireless communication device and the second set of adaptive beam weights may be based on reception of the set of SRSs.

Some examples of the method, apparatus, and non-transitory computer-readable medium described herein may further include operations, features, means, or instructions for transmitting, to the first wireless communication device, an indication of a quantity of antenna elements of the first wireless communication device to use for the adaptive uplink beam training, where reception of the request may be based on the indication of the quantity of antenna elements, and where the quantity of antenna elements may be less than a total quantity of antenna elements of the first wireless communication device.

In some examples of the method, apparatus, and non-transitory computer-readable medium described herein, receiving the request may include operations, features, means, or instructions for receiving an indication of a quantity of antenna elements of the first wireless communication device that the first wireless communication device may be capable of using for the adaptive uplink beam training.

In some examples of the method, apparatus, and non-transitory computer-readable medium described herein, the parameter for the mm wave communications includes a quantity of antenna elements of the first wireless communication device, a quantity of antenna elements of the first wireless communication device, an uplink link budget, a quantity of radio frequency chains at the first wireless communication device, a quantity of radio frequency chains at the second wireless communication device, or a combination thereof.

In some examples of the method, apparatus, and non-transitory computer-readable medium described herein, receiving the set of SRSs may include operations, features, means, or instructions for using, for at least a second subset of the set of SRSs, a second set of beams associated with a set of codebook-based static beam weights for a second set of antenna elements of the first wireless communication device.

In some examples of the method, apparatus, and non-transitory computer-readable medium described herein, the set of antenna elements of the first wireless communication device may be a subset of the second set of antenna elements.

In some examples of the method, apparatus, and non-transitory computer-readable medium described herein, the respective sets of adaptive beam weights include respective phase shift values.

In some examples of the method, apparatus, and non-transitory computer-readable medium described herein, the first wireless communication device may be a UE and the second wireless communication device may be one of a network entity, a relay node, a repeater, or an IAB node.

In some examples of the method, apparatus, and non-transitory computer-readable medium described herein, the first wireless communication device may be one of a relay node, a repeater, a customer premises equipment, or an IAB node and the second wireless communication device may be one of a network entity, a second relay node, a second repeater, or a second IAB node.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports the use of reduced dimensional adaptive beam weights for uplink transmission in accordance with one or more aspects of the present disclosure.

FIG. 2 shows examples of antenna array and beamforming diagrams that supports the use of reduced dimensional adaptive beam weights for uplink transmission in accordance with one or more aspects of the present disclosure.

FIG. 3 shows an example of a wireless communications system that supports the use of reduced dimensional adaptive beam weights for uplink transmission in accordance with one or more aspects of the present disclosure.

FIG. 4 shows an example of an uplink adaptive beam method that supports the use of reduced dimensional adaptive beam weights for uplink transmission in accordance with one or more aspects of the present disclosure.

FIG. 5 shows an example of a process flow that supports the use of reduced dimensional adaptive beam weights for uplink transmission in accordance with one or more aspects of the present disclosure.

FIGS. 6 and 7 show block diagrams of devices that support the use of reduced dimensional adaptive beam weights for uplink transmission in accordance with one or more aspects of the present disclosure.

FIG. 8 shows a block diagram of a communications manager that supports the use of reduced dimensional adaptive beam weights for uplink transmission in accordance with one or more aspects of the present disclosure.

FIG. 9 shows a diagram of a system including a device that supports the use of reduced dimensional adaptive beam weights for uplink transmission in accordance with one or more aspects of the present disclosure.

FIGS. 10 and 11 show block diagrams of devices that support the use of reduced dimensional adaptive beam weights for uplink transmission in accordance with one or more aspects of the present disclosure.

FIG. 12 shows a block diagram of a communications manager that supports the use of reduced dimensional adaptive beam weights for uplink transmission in accordance with one or more aspects of the present disclosure.

FIG. 13 shows a diagram of a system including a device that supports the use of reduced dimensional adaptive beam weights for uplink transmission in accordance with one or more aspects of the present disclosure.

FIGS. 14 and 15 show flowcharts illustrating methods that support the use of reduced dimensional adaptive beam weights for uplink transmission in accordance with one or more aspects of the present disclosure.

### DETAILED DESCRIPTION

In millimeter (mm) wave communications, the communicating devices (e.g., the user equipment (UE) and the network entity) may perform beamforming using multiple antenna elements to improve the link budget. For example, both the receiving device and the transmitting device may use codebook-based directional radio frequency (RF) beamforming. A transmitting device and a receiving device (e.g., a UE and a network entity) may each store a fixed codebook on an RF integrated circuit (RFIC) chip, where the fixed codebook indicates beam weights to apply to different antenna elements to generate beams. The transmitting and receiving devices may perform beamforming using the fixed codebook. For example, a UE may perform a beamformed uplink transmission using the fixed codebook, and the network entity may receive the beamformed uplink transmission using the fixed codebook. Beams formed using the fixed codebook may be referred to as static beams formed via application of static beam weights. Adaptive beam weights (e.g., beam weights other than the beams weights stored in the codebook in the RFIC chip), however, may provide higher throughput in some cases since adaptive beam weights may explore all possibilities of phase shifter and/or amplitude control combinations instead of a select set of phase shifter and/or amplitude control combinations as with the case of static beams. The RFIC chip may be unable to store all possible beam weights due to the memory constraints of the RFIC chip. Further, uplink beam weights for uplink transmissions by UEs may need to be certified by the Federal Communications Commission (FCC) as maximum permissible exposure (MPE) compliant beams. The quantity of possible beam weights may increase as the quantity of transmitting antenna elements increases.

In some aspects, a first wireless communication device (e.g., a UE) may transmit a set of sounding reference signals (SRSs) via a set of beams via application of adaptive beam weights to a subset of the total quantity of antenna elements of the first wireless communication device. Accordingly, the first wireless communication device may perform adaptive beam training, but may reduce the total quantity of possible adaptive beam weights (e.g., as there are fewer antenna elements, there are fewer possible beam weight combinations). The first wireless communication device may request SRS resources from the second wireless communication device (e.g., a network entity such as a gNB) and the second wireless communication device may grant SRS resources for the first wireless communication device to perform the adaptive beam training. The second wireless communication device may measure the SRSs and may estimate the set of adaptive beam weights for the first wireless communication device to use for a subsequent uplink communication. In some examples, the first wireless communication device may also perform beam training using the static beams, where the static beams may involve use of all of the antenna elements of an antenna array of the UE. Further, phase-only control of antenna elements may achieve higher performance than amplitude and phase control of antenna elements. Accordingly, the quantity of adaptive beam weights to train may be reduced while achieving increased performance for uplink via using phase-only control for uplink.

Aspects of the disclosure are initially described in the context of wireless communications systems. Aspects of the disclosure are further illustrated by and described with reference to of antenna array and beamforming diagrams, process flows, apparatus diagrams, system diagrams, and flowcharts that relate to use of reduced dimensional adaptive beam weights for uplink transmission.

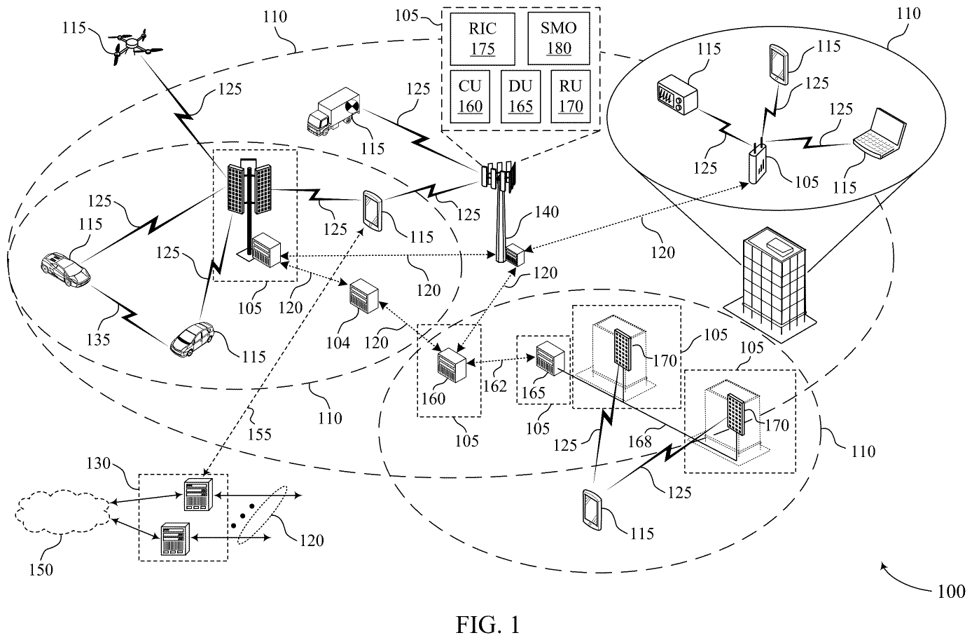

FIG. 1 shows an example of a wireless communications system 100 that supports use of reduced dimensional adaptive beam weights for uplink transmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support use of reduced dimensional adaptive beam weights for uplink transmission as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the mm band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In mm wave communications, the communicating devices (e.g., the UE 115 and the network entity 105) may perform beamforming using multiple antenna elements to improve the link budget. For example, both the receiving device and the transmitting device may use codebook-based directional RF and/or analog beamforming. A transmitting device and a receiving device (e.g., a UE and a network entity) may each store a fixed codebook on an RFIC chip, where the fixed codebook indicates beam weights to apply to different antenna elements to generate beams. The transmitting and receiving devices may perform beam training using the fixed codebook. For example, the devices may perform hierarchical beam training via P-1, P-2, and P-3 for initial acquisition, which may be referred to as the static codebook approach.

Adaptive beam weights (e.g., beam weights other than the beams weights stored in the codebook in the RFIC chip), however, may provide higher throughput in some cases. For example, dynamic beam weights may provide good coverage for wider angular spread scenarios such as higher rates, lower block error ratio (BLER), and/or may be used to mitigate hand blockages of antenna elements on a UE 115. Use of adaptive beam weights (e.g., other than those stored in the static codebook in the RFIC chip memory) may be referred to as a dynamic codebook approach. The RFIC chip may be unable to store all possible beam weights due to the memory constraints of the RFIC chip. Further, the FCC and International Commission on Non-Ionizing Radiation Protection (ICNIRP) may impose MPE constraints for different carrier frequencies. Such MPE constraints may be specified in either short-term or medium-term temporal averaging or local/medium spatial averaging of radiated power. MPE constraints may prevent hazardous operating conditions and may protect the health of a user of a UE 115 as well as may reduce electromagnetic pollution/noise from transmissions. Further, uplink beam weights may be certified by the FCC as MPE compliant. A fixed quantity of static beams may accordingly be certified, but the quantity of possible adaptive beam weights may greatly increase as the quantity of transmitting antenna elements increases.

For example, given a B bit phase shifter, and a B₁ bit amplitude control per antenna for the design of adaptive beam weights, the quantity of such possible beam weights may be large. In such an example, the quantity of possible beam weights may be given as (2^{B})^{N-1}*(2^{B1})^{N} possible different beam weights with N denoting the quantity of antenna elements in the antenna array of the transmitting device. For example, with N=5, B=3 and B₁=4, there would be 4.3*10⁹ possible beam weights. Without amplitude control (e.g., N=5, B=3 and B₁=0), there would be 4096 possible beam weights which may still be too large to be stored in an RFIC chip memory. In the case of a customer premises equipment (CPE) where N=64, with B=3 and B₁=0, there are 7.8*10⁵⁶ possible beam weights, which may be too large to store in an RFIC chip memory and/or to achieve FCC certification for MPE considerations.

The quantity of possible adaptive uplink beam weights reduces as the array dimension becomes smaller (e.g., as less antenna elements are used). Accordingly, in some aspects, static beams may be used for large antenna array dimensions and adaptive beam weights may be used in association with reduced array dimensions. Multiple solutions may be implemented to use adaptive beam weights in association with reduced array dimensions. For example, in a signaling-based implementation, the receiving device (e.g., a network entity) may assist in uplink beam design leading to a combination uplink codebook of static and adaptive beams. As another example, in an implementation-based design, a transmitting device (e.g., a UE) may build uplink beams from downlink beams via restricting uplink beams over a reduced dimensional codebook (e.g., for which FCC MPE certification may be achievable without being onerous).

For downlink communications, a UE 115 may generate adaptive beam weights based on channel training (e.g., either using synchronization signal blocks (SSBs), CSI reference signals (CSI-RSs), or SRSs). Four possible candidate schemes for adaptive beams may be used: 1) amplitude and phase control; 2) phase-only control; 3) phase-only control but amplitude is on/off (on if amplitude exceeds a threshold, off otherwise); and 4) infinite precision adaptive beam weights. Use of amplitude control impacts both the signal and noise equally, and thus may be a good option for downlink but less beneficial for uplink. For uplink, amplitude control as well as infinite precision (e.g., options 1 and 4) may lead to significant loss in performance as amplitude adaptation may lead to loss in equivalent isotropic radiated power (EIRP). Phase-only control accordingly may perform better for uplink as EIRP may not be lost. Empirically, option 3 (phase-only control but amplitude is on/off) has been shown to perform worse than option 2 (phase-only control) for uplink (e.g., in terms of signal-to-noise (SNR) gain).

As phase-only control of antenna elements may achieve higher performance than amplitude and phase control of antenna elements, the quantity of adaptive beam weights to train may be reduced while achieving increased performance for uplink via using phase-only control for uplink (e.g., by setting the value of B₁ in the equation (2^{B})^{N-1}*(2^{B1})^{N} to 0). Additionally, or alternatively, in some aspects, first wireless communication device (e.g., a UE 115) may transmit SRSs via a set of beams with application of adaptive beam weights using a subset of the total quantity of antenna elements of the first wireless communication device. Accordingly, the first wireless communication device may perform adaptive beam training, but may reduce the total quantity of possible adaptive beam weights. The first wireless communication device may request SRS resources from the second wireless communication device (e.g., a network entity such as a gNB) and the second wireless communication device may grant SRS resources for the first wireless communication device to perform the adaptive beam training. The second wireless communication device may measure the SRSs and may estimate the set of adaptive beam weights for the first wireless communication device to use for a subsequent uplink communication. In some examples, the first wireless communication device may also perform beam training using the static beams, where the static beams may involve use of all of the antenna elements of the UE 115.

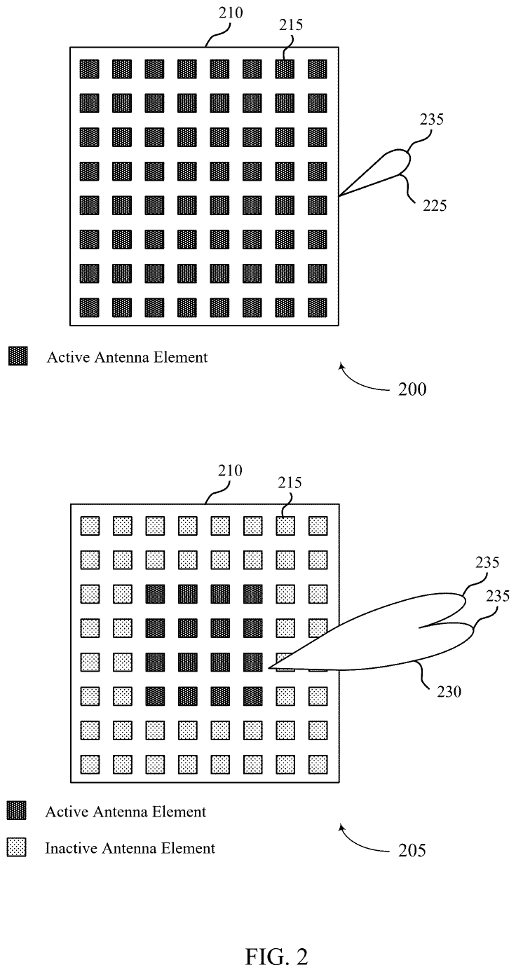

FIG. 2 shows an example of an antenna array and beamforming diagram 200 and an antenna array and beamforming diagram 205 that supports use of reduced dimensional adaptive beam weights for uplink transmission in accordance with one or more aspects of the present disclosure. The antenna array and beamforming diagram 200 and the antenna array and beamforming diagram 205 may implement or may be implemented by aspects of the wireless communications system 100. For example, the beamforming diagram 200 and the antenna array and beamforming diagram 205 illustrate an antenna array 210, which may be the antenna array of a UE 115, an IAB node 104, a relay node, a repeater, a network entity 105.

As shown, the antenna array 210 may include a quantity of antenna elements 215 (e.g., eight antenna elements 215 in the vertical direction and eight antenna elements 215 in the horizontal direction for a total of 64 antenna elements 215). For uplink, a transmitting device that includes the antenna array 210 may use a combination codebook that includes two parts, a static beam part and an adaptive beam part.

As shown in the antenna array and beamforming diagram 200, static beams may be formed via of all of the antenna elements 215 of the antenna array 210 (e.g., all antenna elements 215 of the antenna array 210 may be active). The combination codebook may include a small quantity of static beams. For example, the combination codebook may include six beams in the azimuth scanning direction and six beams in the elevation scanning direction for a total of 36 static beams. Each static beam 225 may be directional and may have a single beamspace peak 235.

As shown in the antenna array and beamforming diagram 205, a subset of the antenna elements 215 of the antenna array 210 may be used to form adaptive beams in the combination codebook. As described herein, reducing the quantity of antenna elements 215 may reduce the quantity of possible adaptive beams. For example, as shown, adaptive beams 230 may be formed via the antenna elements 215 that are active, and a set of the antenna elements 215 of the antenna array 210 may be inactive for adaptive beamforming. Each adaptive beam 230 in the combination codebook may have multiple beamspace peaks 235.

In some examples, a receiving device (e.g., the network entity 105 in uplink) may indicate to the transmitting device the quantity of antenna elements (e.g., the quantity of active antenna elements 215) at the transmitting device side (e.g., the UE 115 in uplink) that are sufficient for the design of adaptive beams to meet uplink link budget or EIRP demands. In some examples, the transmitting device (e.g., the UE 115 in uplink) may indicate how many antenna elements the transmitting device may activate for performing an adaptive beam-based transmission scheme. With the reduced quantity of antenna elements 215 that are active (e.g., referred to as N_{act}), the transmitting device may perform active beam weighting. The reduced quantity of adaptive beams weights over the reduced set may be given by (2^{B}phase)^{N}act⁻¹ possible adaptive beam weights, which may be more manageable to achieve FCC certification than the 2^{B}phase^{N-1} possible adaptive beam weights without reducing the quantity of active antenna elements.

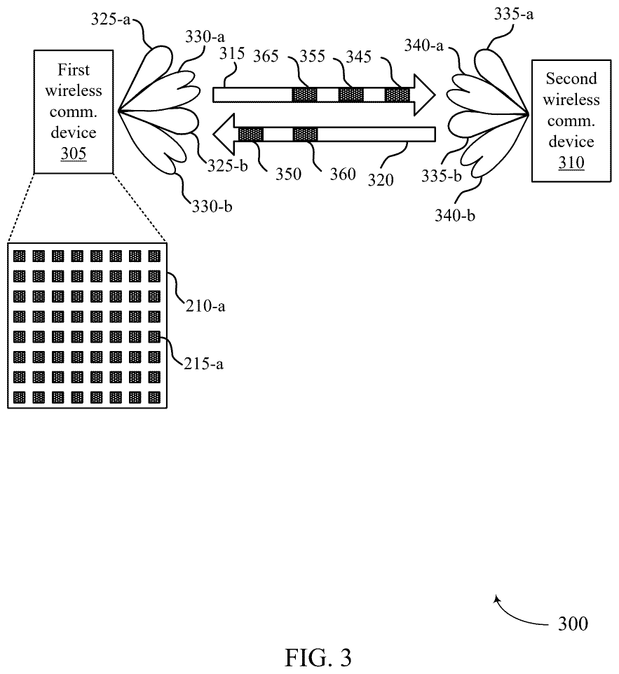

FIG. 3 shows an example of a wireless communications system 300 that supports use of reduced dimensional adaptive beam weights for uplink transmission in accordance with one or more aspects of the present disclosure. The wireless communications system 300 may implement or may be implemented by aspects of the wireless communications system 100, the antenna array and beamforming diagram 200, or the antenna array and beamforming diagram 205.

The wireless communications system 300 may include a first wireless communication device 305 and a second wireless communication device 310. The first wireless communication device 305 may be an example of a UE 115, and IAB node 104, a repeater, or a relay node. The second wireless communication device 310 may be an example of a network entity 105, and IAB node 104, a repeater, or a relay node. The first wireless communication device 305 may transmit uplink communications 315 to the second wireless communication device 310, and the second wireless communication device 310 may transmit downlink communications 320 to the first wireless communication device 305. The first wireless communication device 305 may perform beamforming to transmit uplink communications 315 via a beam as described herein. The second wireless communication device 310 may perform beamforming to receive a beamformed uplink communication 315.

The first wireless communication device 305 may include an antenna array 210-a, which may be an example of an antenna array 210 as described herein. The antenna array may include a set of antenna elements 215-a (e.g., an 8×8 array).

In some examples, as described herein, the first wireless communication device 305 may use a combination codebook of static beams 325 (e.g., a static beam 325-a and a static beam 325-b) and adaptive beams 330 (e.g., an adaptive beam 330-a and an adaptive beam 330-b). As described herein, the first wireless communication device 305 may use a reduced quantity of antenna elements of the antenna array for the adaptive beams 330 than the static beams 325 (e.g., a subset of the antenna elements 215-a may be deactivated for forming the adaptive beams 330).

In some examples, to perform beam training for the combination codebook and/or to perform adaptive beam training, the first wireless communication device 305 may transmit a request 345 to the second wireless communication device 310 for SRS resources for uplink beam training. In some examples, the request 345 may indicate a quantity of requested SRS resources. The second wireless communication device 310 may transmit a grant 350 for a set of SRS opportunities based on the request 345.

The first wireless communication device 305 may transmit a set of SRSs 355 via the SRS opportunities scheduled by the grant, using for at least a subset of the SRSs, the adaptive beams 330 formed by application of sets of adaptive beam weights to the subset of the antenna elements 215 of the antenna array 210. In some examples, the first wireless communication device 305 may use, for another subset of the SRSs, the static beams 325 formed by application of the static beam weights to the antenna elements 215-a of the antenna array 210-a. Accordingly, as described herein, the first wireless communication device 305 may perform beam training using a combination codebook of static beam weights applied to an entirety of the antenna array 210-a and adaptive beam weights applied to a subset of the antenna elements 215-a of the antenna array 210-a.

The second wireless communication device 310 may measure the SRSs and may select a set of beam weights for the first wireless communication device 305 to apply to an uplink communication 365. The second wireless communication device 310 may transmit control signaling 360 to the first wireless communication device 305 that indicates the selected set of beam weights. For example, the determined/selected beam weights may be the beam weights used to form the beam which had a highest received signal strength for the corresponding SRS. The first wireless communication device 305 may transmit an uplink communication 365 using the indicated set of beam weights.

In some examples, if the first wireless communication device 305 uses static beams 325 with the antenna array 210 (e.g., using all of the antenna elements 215-a of the antenna array 210-a), the second wireless communication device 310 may use static receive beams 335 or adaptive receive beams 340 to receive the beamformed communications from the first wireless communication device 305. For example, in a static beam-based approach, the first wireless communication device 305 may use a static beam 325-a for transmission of the uplink communication 365, which the second wireless communication device 310 may receive via a corresponding static receive beam 335-a. In some examples, the static beam 325- b may be used for backup in the case of a blockage of the static beam 325-a, and the static receive beam 335-b may correspond to the static beam 325-b.

In some examples, the second wireless communication device 310 may compensate if the first wireless communication device 305 uses an adaptive beam 330 formed via application of adaptive beam weights applied to a subset of the antenna elements 215-a of the antenna array 210-a. For example, as a reduced set of array dimensions may be used at the first wireless communication device 305 to form an adaptive beam 330, to achieve high performance, the second wireless communication device 310 may apply adaptive beam weights over a full antenna array of the second wireless communication to form adaptive receive beams 340 (e.g., an adaptive receive beam 340-a or an adaptive receive beam 340-b as shown). In some examples, the second wireless communication device 310 may may apply adaptive beam weights over a full antenna array of the second wireless communication to form adaptive receive beams 340 in response to an indication from the first wireless communication device 305 that the first wireless communication device 305 uses a reduced quantity of antenna elements 215-a of the antenna array 210-a for adaptive beam forming.

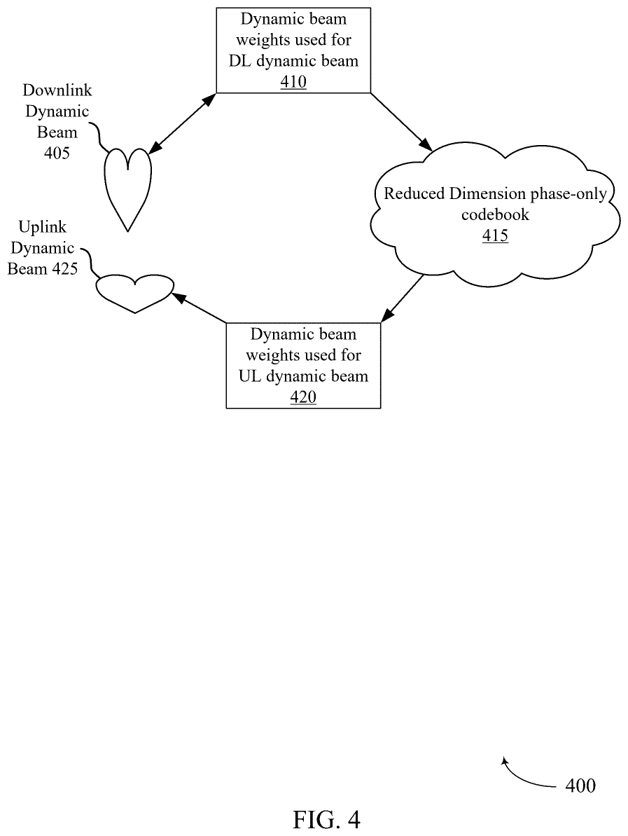

FIG. 4 shows an example of an uplink adaptive beam method 400 that supports use of reduced dimensional adaptive beam weights for uplink transmission in accordance with one or more aspects of the present disclosure. The uplink adaptive beam method may implement or may be implemented by aspects of the wireless communications system 100, the antenna array and beamforming diagram 200, the antenna array and beamforming diagram 205, or the wireless communications system 300. For example, the uplink adaptive beam method may be performed by a first wireless communication device 305 as described herein.

In some examples, a first wireless communication device 305 may use a reduced dimensional phase-only codebook independent of the phase shifting capability available at the first wireless communication device 305 to achieve adaptive uplink beams without a large quantity of candidate adaptive uplink beams. For example, the reduced dimensional phase-only codebook may be built on dynamic downlink beam weights.

For example, the dynamic downlink beam weights 410 used to form an adaptive downlink receive beam 405 may be quantized and converted to a reduced dimension phase-only codebook 415 to generate dynamic adaptive beam weights 420 for forming an uplink adaptive beam 425. For example, considering a Bₚₕₐₛₑ=2 bits only for uplink dynamic beam weights, then there are (2^{B}phase)^{N-1}possible uplink dynamic beam weights. With N=5, then the reduced dimension codebook has a size of 256 possible uplink dynamic beam weights, which may be stored in an RFIC memory and may be certified by the FCC for MPE compliance.

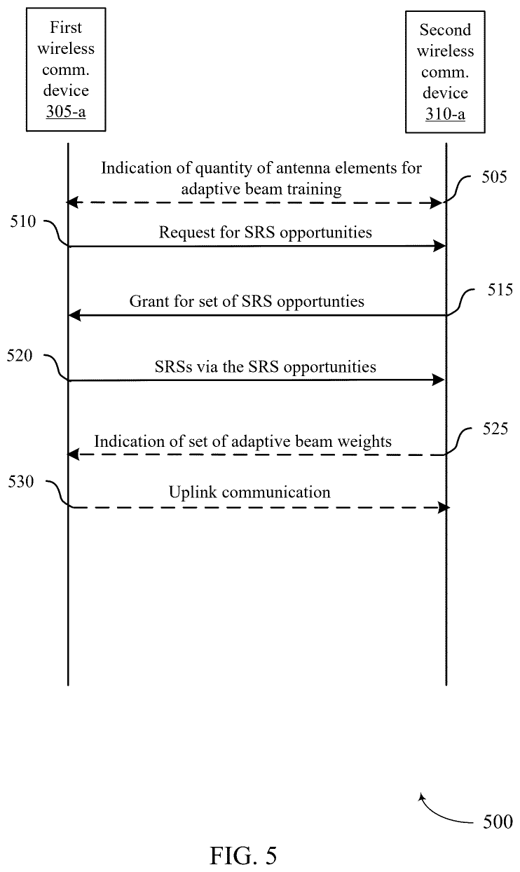

FIG. 5 shows an example of a process flow 500 that supports use of reduced dimensional adaptive beam weights for uplink transmission in accordance with one or more aspects of the present disclosure. The process flow 500 may include a first wireless communication device 305-a, which may be an example of a first wireless communication device 305 as described herein. The process flow 500 may include a second wireless communication device 310-a, which may be an example of a second wireless communication device 310 as described herein. In the following description of the process flow 500, the communications between the first wireless communication device 305-a and the second wireless communication device 310-a may be transmitted in a different order than the example order shown, or the operations performed by the first wireless communication device 305-a and the second wireless communication device 310-a may be performed in different orders or at different times. Some operations also may be omitted from the process flow 500, and other operations may be added to the process flow 500.

At 510, the first wireless communication device 305-a may transmit, to the second wireless communication device 310-a, a request for a quantity of SRS opportunities to perform adaptive uplink beam training for mm wave communications between the first wireless communication device 305-a and the second wireless communication device 310-a. The quantity of SRS opportunities may be based on a parameter for the mm wave communications. In some examples, the parameter for the mm wave communications may be a quantity of antenna elements of the first wireless communication device, a quantity of antenna elements of the first wireless communication device, an uplink link budget, a quantity of radio frequency chains at the first wireless communication device, a quantity of radio frequency chains at the second wireless communication device, or a combination thereof. In some examples, the mm wave communications may be any frequency over 24.25 GHz (e.g., frequency range 2 and beyond).

At 515, the first wireless communication device 305-a may receive, from the second wireless communication device 310-a, a grant for a set of SRS opportunities. The set of SRS opportunities may be based on the quantity requested by the first wireless communication device 305-a.

At 520, the first wireless communication device 305-a may transmit a set of SRSs via the set of SRS opportunities using, for at least a subset of the set of SRSs, a set of beams formed by application of respective sets of adaptive beam weights to a set of antenna elements of the first wireless communication device 305-a. The second wireless communication device 310-a may receive the set of SRSs. For example, the first wireless communication device 305-a may beam train the second wireless communication device 310-a over the granted SRS opportunities. In some examples, the respective sets of adaptive beam weights may include respective phase shift values.

In some examples, the first wireless communication device 305-a may use, for at least a second subset of the set of SRSs, a second set of beams via application of a set of codebook-based static beam weights to a second set of antenna elements of the first wireless communication device 305-a. In some examples, the set of antenna elements of the first wireless communication device 305-a are a subset of the second set of antenna elements. In some examples, the second wireless communication device 310-a may use, for at least a second subset of the set of SRSs, a second set of beams associated with the set of codebook-based static beam weights for a second set of antenna elements of the first wireless communication device 305-a.

In some examples, at 525 the first wireless communication device 305-a may receive, from the second wireless communication device 310-a and based on the set of SRSs, an indication of a set of adaptive beam weights to apply to the set of antenna elements for an uplink communication. In some such examples, at 530, the first wireless communication device 305-a may perform the uplink communication via an application of the set of adaptive beam weights to the set of antenna elements, and the second wireless communication device 310-a may receive the uplink communication using a beam associated with the set of adaptive beam weights. For example, the second wireless communication device 310-a may estimate a set of adaptive beam weights for both the second wireless communication device 310-a and the first wireless communication device 305-a based on measurements of the SRSs at 520, and may indicate the set of adaptive beam weights for the first wireless communication device 305-a to the first wireless communication device 305-a based on the measurements of the SRSs. The second wireless communication device 310-a may use adaptive beam weights to form an adaptive receive beam to receive the uplink communication that corresponds to the adaptive beam formed by application of the indicated adaptive beam weights at the first wireless communication device 305-a.

In some examples, at 505, the first wireless communication device 305-a may receive, from the second wireless communication device 310-a, an indication of a quantity of antenna elements of the first wireless communication device to use for the adaptive uplink beam training, and transmission of the request at 510 may be based on the indication of the quantity of antenna elements. The quantity of antenna elements indicated at 505 may be less than a total quantity of antenna elements available at the first wireless communication device. In some examples, at 505, the first wireless communication device 305-a may transmit, to the second wireless communication device 310-a, an indication of a quantity of antenna elements of the first wireless communication device that the first wireless communication device is capable of using for the adaptive uplink beam training.

In some examples, the first wireless communication device 305-a is a UE, and the second wireless communication device 310-a is one of a network entity, a relay node, a repeater, or an IAB node.

In some examples, the first wireless communication device 305-a is one of: a relay node, a repeater, a customer premises equipment, or an IAB node; and the second wireless communication device 310-a is one of: a network entity, a second relay node, a second repeater, or a second IAB node.

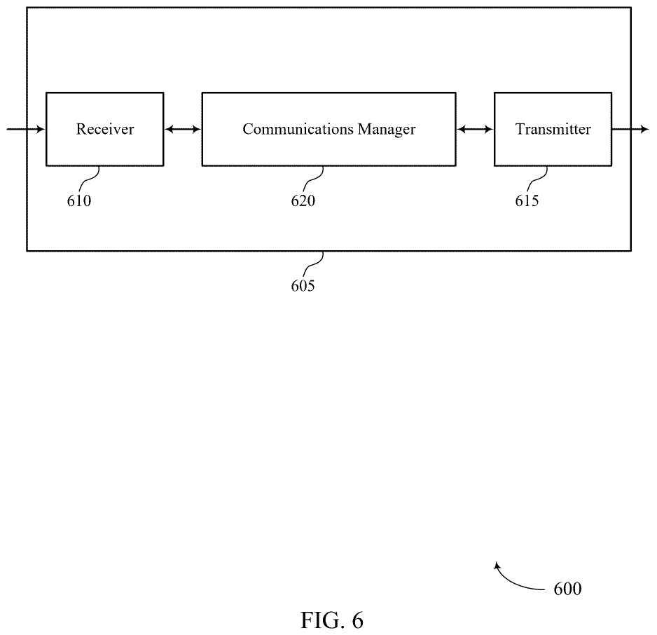

FIG. 6 shows a block diagram 600 of a device 605 that supports use of reduced dimensional adaptive beam weights for uplink transmission in accordance with one or more aspects of the present disclosure. The device 605 may be an example of aspects of a UE 115 or a first wireless communication device 305 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to use of reduced dimensional adaptive beam weights for uplink transmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to use of reduced dimensional adaptive beam weights for uplink transmission). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of use of reduced dimensional adaptive beam weights for uplink transmission as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The communications manager 620 is capable of, configured to, or operable to support a means for receiving, from the second wireless communication device, a grant for a set of SRS opportunities, where the set of SRS opportunities is based on the quantity requested by the first wireless communication device. The communications manager 620 is capable of, configured to, or operable to support a means for transmitting a set of SRSs via the set of SRS opportunities and using, for at least a subset of the set of SRSs, a set of beams formed by application of respective sets of adaptive beam weights to a set of antenna elements of the first wireless communication device.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

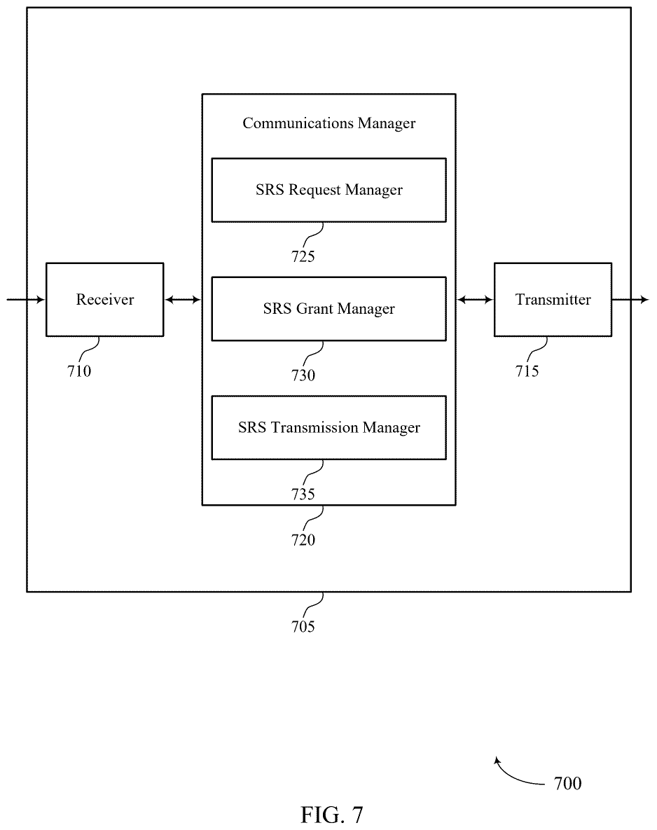

FIG. 7 shows a block diagram 700 of a device 705 that supports use of reduced dimensional adaptive beam weights for uplink transmission in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to use of reduced dimensional adaptive beam weights for uplink transmission). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to use of reduced dimensional adaptive beam weights for uplink transmission). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of use of reduced dimensional adaptive beam weights for uplink transmission as described herein. For example, the communications manager 720 may include an SRS request manager 725, an SRS grant manager 730, an SRS transmission manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The SRS request manager 725 is capable of, configured to, or operable to support a means for transmitting, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The SRS grant manager 730 is capable of, configured to, or operable to support a means for receiving, from the second wireless communication device, a grant for a set of SRS opportunities, where the set of SRS opportunities is based on the quantity requested by the first wireless communication device. The SRS transmission manager 735 is capable of, configured to, or operable to support a means for transmitting a set of SRSs via the set of SRS opportunities and using, for at least a subset of the set of SRSs, a set of beams formed by application of respective sets of adaptive beam weights to a set of antenna elements of the first wireless communication device.

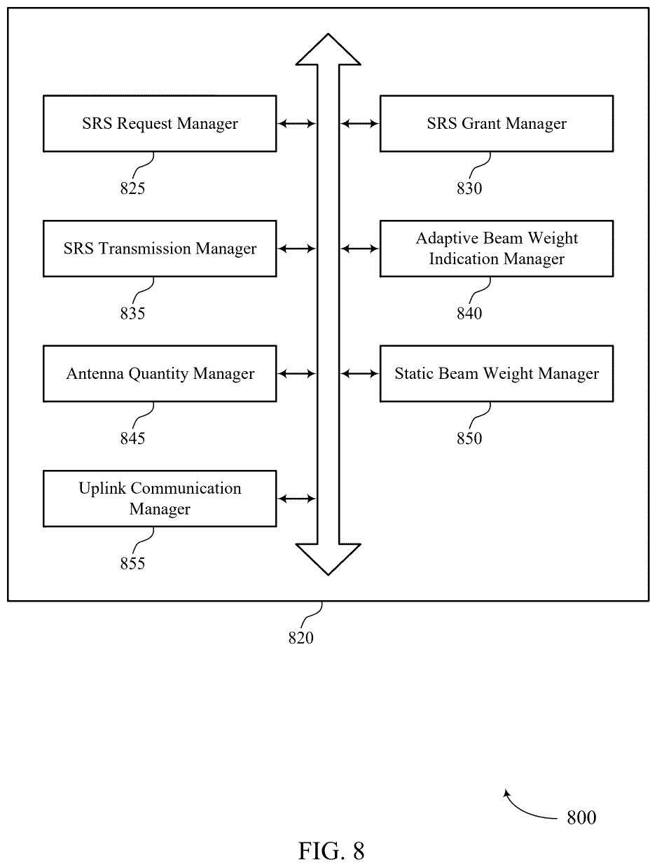

FIG. 8 shows a block diagram 800 of a communications manager 820 that supports use of reduced dimensional adaptive beam weights for uplink transmission in accordance with one or more aspects of the present disclosure. The communications manager 820 may be an example of aspects of a communications manager 620, a communications manager 720, or both, as described herein. The communications manager 820, or various components thereof, may be an example of means for performing various aspects of use of reduced dimensional adaptive beam weights for uplink transmission as described herein. For example, the communications manager 820 may include an SRS request manager 825, an SRS grant manager 830, an SRS transmission manager 835, an adaptive beam weight indication manager 840, an antenna quantity manager 845, a static beam weight manager 850, an uplink communication manager 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The SRS request manager 825 is capable of, configured to, or operable to support a means for transmitting, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The SRS grant manager 830 is capable of, configured to, or operable to support a means for receiving, from the second wireless communication device, a grant for a set of SRS opportunities, where the set of SRS opportunities is based on the quantity requested by the first wireless communication device. The SRS transmission manager 835 is capable of, configured to, or operable to support a means for transmitting a set of SRSs via the set of SRS opportunities and using, for at least a subset of the set of SRSs, a set of beams formed by application of respective sets of adaptive beam weights to a set of antenna elements of the first wireless communication device.

In some examples, the adaptive beam weight indication manager 840 is capable of, configured to, or operable to support a means for receiving, from the second wireless communication device and based on transmitting the set of SRSs, an indication of a set of adaptive beam weights to apply to the set of antenna elements for an uplink communication.

In some examples, the uplink communication manager 855 is capable of, configured to, or operable to support a means for performing the uplink communication via an application of the set of adaptive beam weights to the set of antenna elements.

In some examples, the antenna quantity manager 845 is capable of, configured to, or operable to support a means for receiving, from the second wireless communication device, an indication of a quantity of antenna elements of the first wireless communication device to use for the adaptive uplink beam training, where transmission of the request is based on the indication of the quantity of antenna elements, and where the quantity of antenna elements is less than a total quantity of antenna elements available at the first wireless communication device.

In some examples, to support transmitting the request, the antenna quantity manager 845 is capable of, configured to, or operable to support a means for transmitting an indication of a quantity of antenna elements of the first wireless communication device that the first wireless communication device is capable of using for the adaptive uplink beam training.

In some examples, the parameter for the mm wave communications includes a quantity of antenna elements of the first wireless communication device, a quantity of antenna elements of the first wireless communication device, an uplink link budget, a quantity of radio frequency chains at the first wireless communication device, a quantity of radio frequency chains at the second wireless communication device, or a combination thereof.

In some examples, to support transmitting the set of SRSs, the static beam weight manager 850 is capable of, configured to, or operable to support a means for using, for at least a second subset of the set of SRSs, a second set of beams via application of a set of codebook-based static beam weights to a second set of antenna elements of the first wireless communication device.

In some examples, the set of antenna elements of the first wireless communication device are a subset of the second set of antenna elements.

In some examples, the respective sets of adaptive beam weights include respective phase shift values.

In some examples, the first wireless communication device is a user equipment. In some examples, the second wireless communication device is one of a network entity, a relay node, a repeater, or an IAB node.

In some examples, the first wireless communication device is one of a relay node, a repeater, a customer premises equipment, or an IAB node. In some examples, the second wireless communication device is one of a network entity, a second relay node, a second repeater, or a second IAB node.

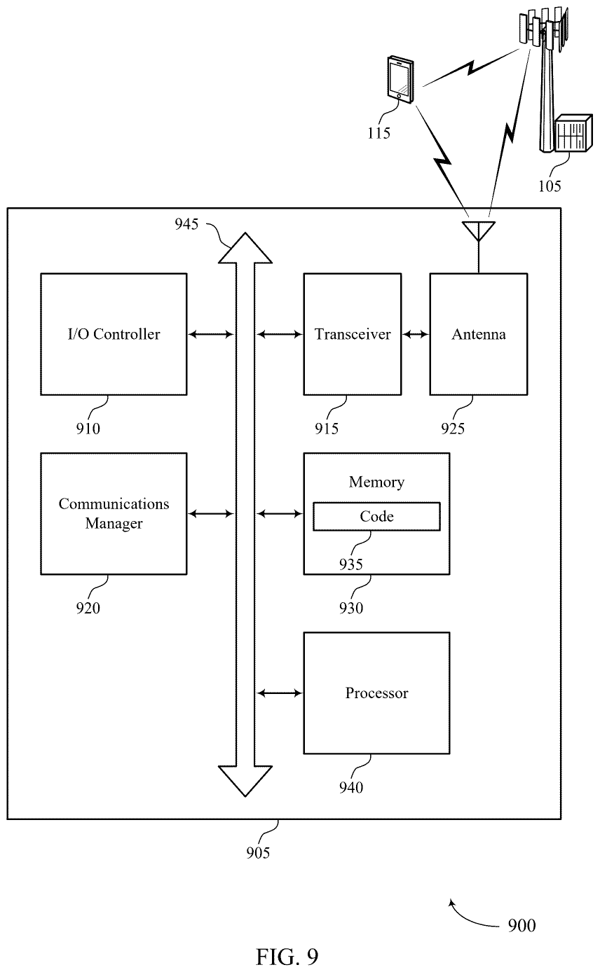

FIG. 9 shows a diagram of a system 900 including a device 905 that supports use of reduced dimensional adaptive beam weights for uplink transmission in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting use of reduced dimensional adaptive beam weights for uplink transmission). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The communications manager 920 is capable of, configured to, or operable to support a means for receiving, from the second wireless communication device, a grant for a set of SRS opportunities, where the set of SRS opportunities is based on the quantity requested by the first wireless communication device. The communications manager 920 is capable of, configured to, or operable to support a means for transmitting a set of SRSs via the set of SRS opportunities and using, for at least a subset of the set of SRSs, a set of beams formed by application of respective sets of adaptive beam weights to a set of antenna elements of the first wireless communication device.

By including or configuring the communications manager 920 in accordance with examples as described herein, the device 905 may support techniques for improved communication reliability, reduced power consumption, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of use of reduced dimensional adaptive beam weights for uplink transmission as described herein, or the at least one processor 940 and the at least one memory 930 may be otherwise configured to, individually or collectively, perform or support such operations.

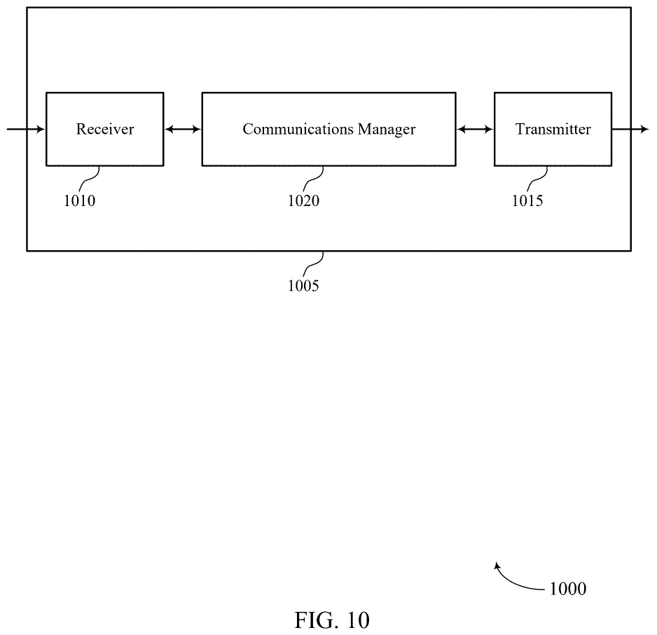

FIG. 10 shows a block diagram 1000 of a device 1005 that supports use of reduced dimensional adaptive beam weights for uplink transmission in accordance with one or more aspects of the present disclosure. The device 1005 may be an example of aspects of a network entity 105 or a second wireless communication device 310 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of use of reduced dimensional adaptive beam weights for uplink transmission as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications a second wireless communication device in accordance with examples as disclosed herein. For example, the communications manager 1020 is capable of, configured to, or operable to support a means for receiving, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The communications manager 1020 is capable of, configured to, or operable to support a means for transmitting, to the first wireless communication device, a grant for a set of SRS opportunities, where the set of SRS opportunities is based on the quantity requested by the first wireless communication device. The communications manager 1020 is capable of, configured to, or operable to support a means for receiving, from the first wireless communication device, a set of SRSs via the set of SRS opportunities and using, for at least a subset of the set of SRSs, a set of beams associated with respective sets of adaptive beam weights for a set of antenna elements of the first wireless communication device.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

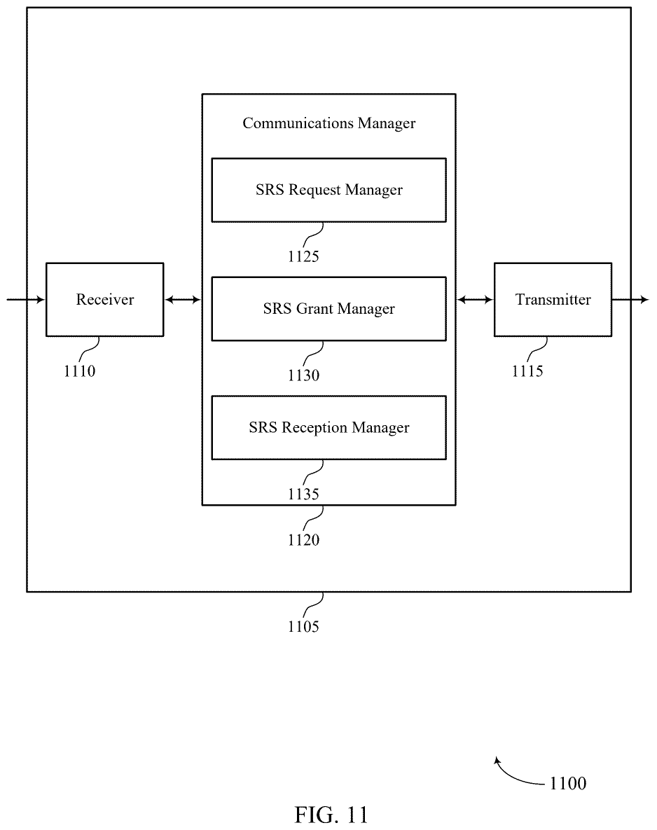

FIG. 11 shows a block diagram 1100 of a device 1105 that supports use of reduced dimensional adaptive beam weights for uplink transmission in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of use of reduced dimensional adaptive beam weights for uplink transmission as described herein. For example, the communications manager 1120 may include an SRS request manager 1125, an SRS grant manager 1130, an SRS reception manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications a second wireless communication device in accordance with examples as disclosed herein. The SRS request manager 1125 is capable of, configured to, or operable to support a means for receiving, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The SRS grant manager 1130 is capable of, configured to, or operable to support a means for transmitting, to the first wireless communication device, a grant for a set of SRS opportunities, where the set of SRS opportunities is based on the quantity requested by the first wireless communication device. The SRS reception manager 1135 is capable of, configured to, or operable to support a means for receiving, from the first wireless communication device, a set of SRSs via the set of SRS opportunities and using, for at least a subset of the set of SRSs, a set of beams associated with respective sets of adaptive beam weights for a set of antenna elements of the first wireless communication device.

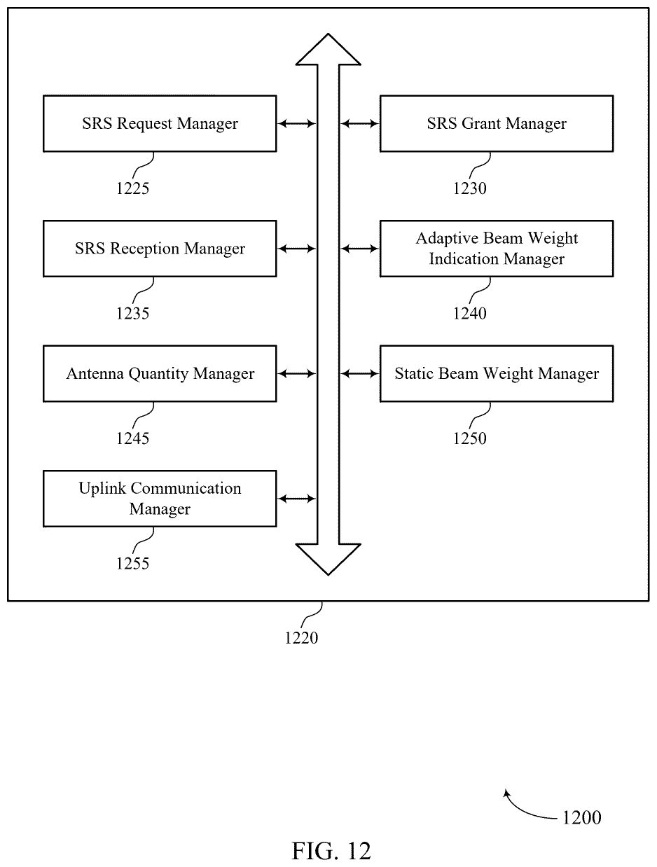

FIG. 12 shows a block diagram 1200 of a communications manager 1220 that supports use of reduced dimensional adaptive beam weights for uplink transmission in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of use of reduced dimensional adaptive beam weights for uplink transmission as described herein. For example, the communications manager 1220 may include an SRS request manager 1225, an SRS grant manager 1230, an SRS reception manager 1235, an adaptive beam weight indication manager 1240, an antenna quantity manager 1245, a static beam weight manager 1250, an uplink communication manager 1255, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications a second wireless communication device in accordance with examples as disclosed herein. The SRS request manager 1225 is capable of, configured to, or operable to support a means for receiving, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The SRS grant manager 1230 is capable of, configured to, or operable to support a means for transmitting, to the first wireless communication device, a grant for a set of SRS opportunities, where the set of SRS opportunities is based on the quantity requested by the first wireless communication device. The SRS reception manager 1235 is capable of, configured to, or operable to support a means for receiving, from the first wireless communication device, a set of SRSs via the set of SRS opportunities and using, for at least a subset of the set of SRSs, a set of beams associated with respective sets of adaptive beam weights for a set of antenna elements of the first wireless communication device.

In some examples, the adaptive beam weight indication manager 1240 is capable of, configured to, or operable to support a means for transmitting, to the first wireless communication device and based on reception of the set of SRSs, an indication of a set of adaptive beam weights to apply to the set of antenna elements for an uplink communication.

In some examples, the uplink communication manager 1255 is capable of, configured to, or operable to support a means for receiving the uplink communication using a beam associated with the set of adaptive beam weights.

In some examples, the beam is associated with a second set of adaptive beam weights applied to a second set of antennas of the second wireless communication device. In some examples, the second set of adaptive beam weights are based on reception of the set of SRSs.

In some examples, the antenna quantity manager 1245 is capable of, configured to, or operable to support a means for transmitting, to the first wireless communication device, an indication of a quantity of antenna elements of the first wireless communication device to use for the adaptive uplink beam training, where reception of the request is based on the indication of the quantity of antenna elements, and where the quantity of antenna elements is less than a total quantity of antenna elements of the first wireless communication device.

In some examples, to support receiving the request, the antenna quantity manager 1245 is capable of, configured to, or operable to support a means for receiving an indication of a quantity of antenna elements of the first wireless communication device that the first wireless communication device is capable of using for the adaptive uplink beam training.

In some examples, the parameter for the mm wave communications includes a quantity of antenna elements of the first wireless communication device, a quantity of antenna elements of the first wireless communication device, an uplink link budget, a quantity of radio frequency chains at the first wireless communication device, a quantity of radio frequency chains at the second wireless communication device, or a combination thereof.

In some examples, to support receiving the set of SRSs, the static beam weight manager 1250 is capable of, configured to, or operable to support a means for using, for at least a second subset of the set of SRSs, a second set of beams associated with of a set of codebook-based static beam weights for a second set of antenna elements of the first wireless communication device.

In some examples, the set of antenna elements of the first wireless communication device are a subset of the second set of antenna elements.

In some examples, the respective sets of adaptive beam weights include respective phase shift values.

In some examples, the first wireless communication device is a user equipment. In some examples, the second wireless communication device is one of a network entity, a relay node, a repeater, or an IAB node.

In some examples, the first wireless communication device is one of a relay node, a repeater, a customer premises equipment, or an IAB node. In some examples, the second wireless communication device is one of a network entity, a second relay node, a second repeater, or a second IAB node.

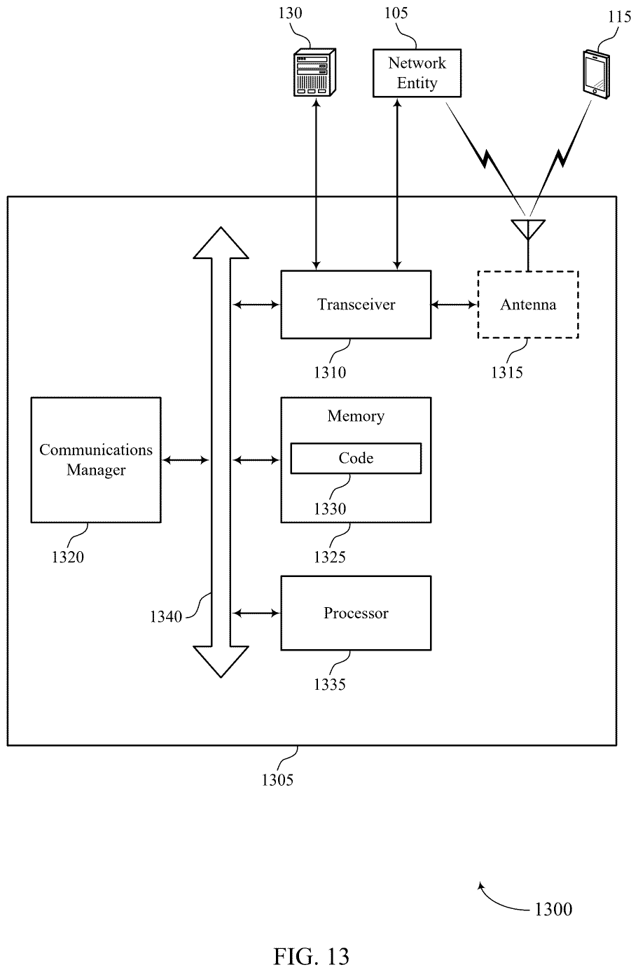

FIG. 13 shows a diagram of a system 1300 including a device 1305 that supports use of reduced dimensional adaptive beam weights for uplink transmission in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting use of reduced dimensional adaptive beam weights for uplink transmission). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications a second wireless communication device in accordance with examples as disclosed herein. For example, the communications manager 1320 is capable of, configured to, or operable to support a means for receiving, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The communications manager 1320 is capable of, configured to, or operable to support a means for transmitting, to the first wireless communication device, a grant for a set of SRS opportunities, where the set of SRS opportunities is based on the quantity requested by the first wireless communication device. The communications manager 1320 is capable of, configured to, or operable to support a means for receiving, from the first wireless communication device, a set of SRSs via the set of SRS opportunities and using, for at least a subset of the set of SRSs, a set of beams associated with respective sets of adaptive beam weights for a set of antenna elements of the first wireless communication device.

By including or configuring the communications manager 1320 in accordance with examples as described herein, the device 1305 may support techniques for improved communication reliability, reduced power consumption, more efficient utilization of communication resources, improved coordination between devices, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of use of reduced dimensional adaptive beam weights for uplink transmission as described herein, or the at least one processor 1335 and the at least one memory 1325 may be otherwise configured to, individually or collectively, perform or support such operations.

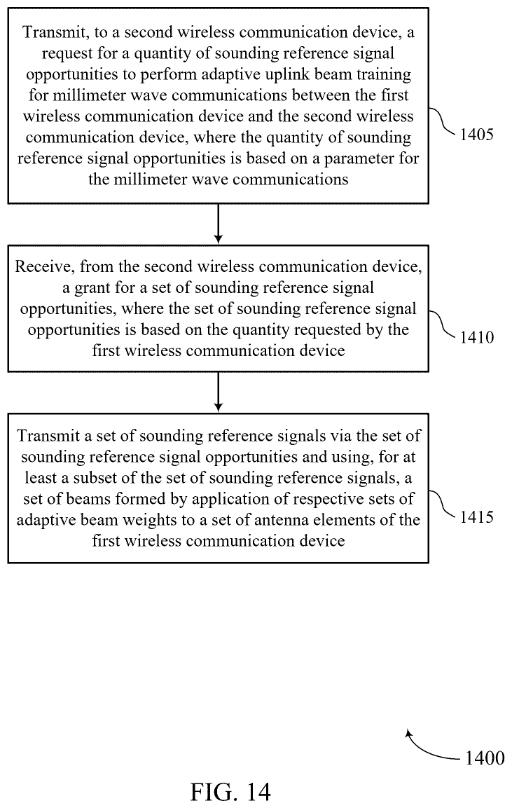

FIG. 14 shows a flowchart illustrating a method 1400 that supports use of reduced dimensional adaptive beam weights for uplink transmission in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, to a second wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The operations of 1405 may be performed in accordance with examples as disclosed herein. In some examples, aspects of the operations of 1405 may be performed by an SRS request manager 825 as described with reference to FIG. 8.

At 1410, the method may include receiving, from the second wireless communication device, a grant for a set of SRS opportunities, where the set of SRS opportunities is based on the quantity requested by the first wireless communication device. The operations of 1410 may be performed in accordance with examples as disclosed herein. In some examples, aspects of the operations of 1410 may be performed by an SRS grant manager 830 as described with reference to FIG. 8.

At 1415, the method may include transmitting a set of SRSs via the set of SRS opportunities and using, for at least a subset of the set of SRSs, a set of beams formed by application of respective sets of adaptive beam weights to a set of antenna elements of the first wireless communication device. The operations of 1415 may be performed in accordance with examples as disclosed herein. In some examples, aspects of the operations of 1415 may be performed by an SRS transmission manager 835 as described with reference to FIG. 8.

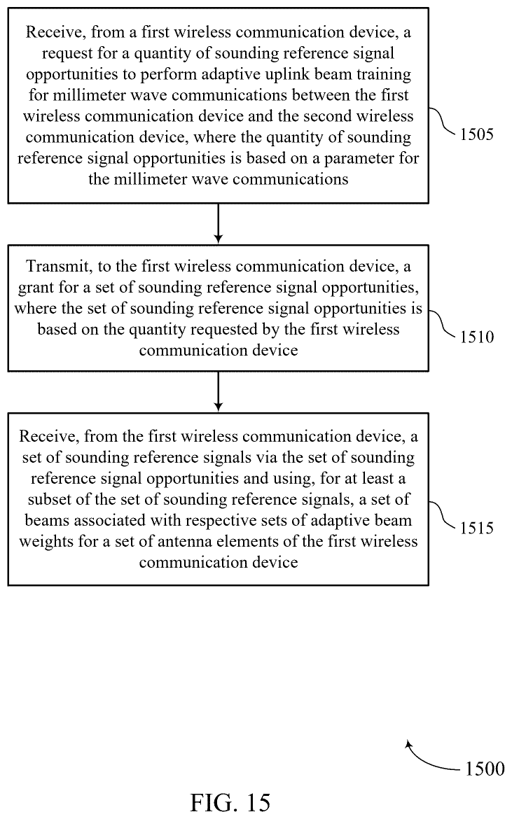

FIG. 15 shows a flowchart illustrating a method 1500 that supports use of reduced dimensional adaptive beam weights for uplink transmission in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a first wireless communication device, a request for a quantity of SRS opportunities to perform adaptive uplink beam training for mm wave communications between the first wireless communication device and the second wireless communication device, where the quantity of SRS opportunities is based on a parameter for the mm wave communications. The operations of 1505 may be performed in accordance with examples as disclosed herein. In some examples, aspects of the operations of 1505 may be performed by an SRS request manager 1225 as described with reference to FIG. 12.

At 1510, the method may include transmitting, to the first wireless communication device, a grant for a set of SRS opportunities, where the set of SRS opportunities is based on the quantity requested by the first wireless communication device. The operations of 1510 may be performed in accordance with examples as disclosed herein. In some examples, aspects of the operations of 1510 may be performed by an SRS grant manager 1230 as described with reference to FIG. 12.

At 1515, the method may include receiving, from the first wireless communication device, a set of SRSs via the set of SRS opportunities and using, for at least a subset of the set of SRSs, a set of beams associated with respective sets of adaptive beam weights for a set of antenna elements of the first wireless communication device. The operations of 1515 may be performed in accordance with examples as disclosed herein. In some examples, aspects of the operations of 1515 may be performed by an SRS reception manager 1235 as described with reference to FIG. 12.

The following provides an overview of aspects of the present disclosure:

Aspect 1: A method for wireless communications at a first wireless communication device, comprising: transmitting, to a second wireless communication device, a request for a quantity of SRS opportunities to perform adaptive uplink beam training for mm wave communications between the first wireless communication device and the second wireless communication device, wherein the quantity of SRS opportunities is based at least in part on a parameter for the mm wave communications; receiving, from the second wireless communication device, a grant for a set of SRS opportunities, wherein the set of SRS opportunities is based at least in part on the quantity requested by the first wireless communication device; and transmitting a set of SRSs via the set of SRS opportunities and using, for at least a subset of the set of SRSs, a set of beams formed by application of respective sets of adaptive beam weights to a set of antenna elements of the first wireless communication device.

Aspect 2: The method of aspect 1, further comprising: receiving, from the second wireless communication device and based at least in part on transmitting the set of SRSs, an indication of a set of adaptive beam weights to apply to the set of antenna elements for an uplink communication.

Aspect 3: The method of aspect 2, further comprising: performing the uplink communication via an application of the set of adaptive beam weights to the set of antenna elements.

Aspect 4: The method of any of aspects 1 through 3, further comprising: receiving, from the second wireless communication device, an indication of a quantity of antenna elements of the first wireless communication device to use for the adaptive uplink beam training, wherein transmission of the request is based at least in part on the indication of the quantity of antenna elements, and wherein the quantity of antenna elements is less than a total quantity of antenna elements available at the first wireless communication device.

Aspect 5: The method of any of aspects 1 through 4, wherein transmitting the request comprises: transmitting an indication of a quantity of antenna elements of the first wireless communication device that the first wireless communication device is capable of using for the adaptive uplink beam training.

Aspect 6: The method of any of aspects 1 through 5, wherein the parameter for the mm wave communications comprises a quantity of antenna elements of the first wireless communication device, a quantity of antenna elements of the first wireless communication device, an uplink link budget, a quantity of RF chains at the first wireless communication device, a quantity of RF chains at the second wireless communication device, or a combination thereof.

Aspect 7: The method of any of aspects 1 through 6, wherein transmitting the set of SRSs comprises: using, for at least a second subset of the set of SRSs, a second set of beams via application of a set of codebook-based static beam weights to a second set of antenna elements of the first wireless communication device.

Aspect 8: The method of aspect 7, wherein the set of antenna elements of the first wireless communication device are a subset of the second set of antenna elements.

Aspect 9: The method of any of aspects 1 through 8, wherein the respective sets of adaptive beam weights comprise respective phase shift values.

Aspect 10: The method of any of aspects 1 through 9, wherein the first wireless communication device is a UE, and the second wireless communication device is one of a network entity, a relay node, a repeater, or an IAB node.

Aspect 11: The method of any of aspects 1 through 9, wherein the first wireless communication device is one of a relay node, a repeater, a customer premises equipment, or an IAB node, and the second wireless communication device is one of a network entity, a second relay node, a second repeater, or a second IAB node.

Aspect 12: A method for wireless communications a second wireless communication device, comprising: receiving, from a first wireless communication device, a request for a quantity of SRS opportunities to perform adaptive uplink beam training for mm wave communications between the first wireless communication device and the second wireless communication device, wherein the quantity of SRS opportunities is based at least in part on a parameter for the mm wave communications; transmitting, to the first wireless communication device, a grant for a set of SRS opportunities, wherein the set of SRS opportunities is based at least in part on the quantity requested by the first wireless communication device; and receiving, from the first wireless communication device, a set of SRSs via the set of SRS opportunities and using, for at least a subset of the set of SRSs, a set of beams associated with respective sets of adaptive beam weights for a set of antenna elements of the first wireless communication device.

Aspect 13: The method of aspect 12, further comprising: transmitting, to the first wireless communication device and based at least in part on reception of the set of SRSs, an indication of a set of adaptive beam weights to apply to the set of antenna elements for an uplink communication.

Aspect 14: The method of aspect 13, further comprising: receiving the uplink communication using a beam associated with the set of adaptive beam weights.

Aspect 15: The method of aspect 14, wherein the beam is associated with a second set of adaptive beam weights applied to a second set of antennas of the second wireless communication device, and the second set of adaptive beam weights are based at least in part on reception of the set of SRSs.

Aspect 16: The method of any of aspects 12 through 15, further comprising: transmitting, to the first wireless communication device, an indication of a quantity of antenna elements of the first wireless communication device to use for the adaptive uplink beam training, wherein reception of the request is based at least in part on the indication of the quantity of antenna elements, and wherein the quantity of antenna elements is less than a total quantity of antenna elements of the first wireless communication device.

Aspect 17: The method of any of aspects 12 through 16, wherein receiving the request comprises: receiving an indication of a quantity of antenna elements of the first wireless communication device that the first wireless communication device is capable of using for the adaptive uplink beam training.

Aspect 18: The method of any of aspects 12 through 17, wherein the parameter for the mm wave communications comprises a quantity of antenna elements of the first wireless communication device, a quantity of antenna elements of the first wireless communication device, an uplink link budget, a quantity of RF chains at the first wireless communication device, a quantity of RF chains at the second wireless communication device, or a combination thereof.

Aspect 19: The method of any of aspects 12 through 18, wherein receiving the set of SRSs comprises: using, for at least a second subset of the set of SRSs, a second set of beams associated with a set of codebook-based static beam weights for a second set of antenna elements of the first wireless communication device.

Aspect 20: The method of aspect 19, wherein the set of antenna elements of the first wireless communication device are a subset of the second set of antenna elements.

Aspect 21: The method of any of aspects 12 through 20, wherein the respective sets of adaptive beam weights comprise respective phase shift values.

Aspect 22: The method of any of aspects 12 through 21, wherein the first wireless communication device is a UE, and the second wireless communication device is one of a network entity, a relay node, a repeater, or an IAB node.

Aspect 23: The method of any of aspects 12 through 21, wherein the first wireless communication device is one of a relay node, a repeater, a customer premises equipment, or an IAB node, and the second wireless communication device is one of a network entity, a second relay node, a second repeater, or a second IAB node.

Aspect 24: A first wireless communication device for wireless communications, comprising one or more memories storing processor-executable code, and one or more processors coupled with the one or more memories and individually or collectively operable to execute the code to cause the first wireless communication device to perform a method of any of aspects 1 through 11.

Aspect 25: A first wireless communication device for wireless communications, comprising at least one means for performing a method of any of aspects 1 through 11.

Aspect 26: A non-transitory computer-readable medium storing code for wireless communications, the code comprising instructions executable by one or more processors to perform a method of any of aspects 1 through 11.

Aspect 27: An apparatus for wireless communications a second wireless communication device, comprising one or more memories storing processor-executable code, and one or more processors coupled with the one or more memories and individually or collectively operable to execute the code to cause the apparatus to perform a method of any of aspects 12 through 23.

Aspect 28: An apparatus for wireless communications a second wireless communication device, comprising at least one means for performing a method of any of aspects 12 through 23.

Aspect 29: A non-transitory computer-readable medium storing code for wireless communications a second wireless communication device, the code comprising instructions executable by one or more processors to perform a method of any of aspects 12 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless communication device, comprising:
one or more memories storing processor-executable code; and
one or more processors coupled with the one or more memories and individually or collectively operable to execute the code to cause the first wireless communication device to:
transmit, to a second wireless communication device, a request for a quantity of sounding reference signal opportunities to perform adaptive uplink beam training for millimeter wave communications between the first wireless communication device and the second wireless communication device, wherein the quantity of sounding reference signal opportunities is based at least in part on a parameter for the millimeter wave communications;
receive, from the second wireless communication device, a grant for a set of sounding reference signal opportunities, wherein the set of sounding reference signal opportunities is based at least in part on the quantity requested by the first wireless communication device; and
transmit a set of sounding reference signals via the set of sounding reference signal opportunities and using, for at least a subset of the set of sounding reference signals, a set of beams formed by application of respective sets of adaptive beam weights to a set of antenna elements of the first wireless communication device.

2. The first wireless communication device of claim 1, wherein the one or more processors are individually or collectively further operable to execute the code to cause the first wireless communication device to:
receive, from the second wireless communication device and based at least in part on transmitting the set of sounding reference signals, an indication of a set of adaptive beam weights to apply to the set of antenna elements for an uplink communication.

3. The first wireless communication device of claim 2, wherein the one or more processors are individually or collectively further operable to execute the code to cause the first wireless communication device to:
perform the uplink communication via an application of the set of adaptive beam weights to the set of antenna elements.

4. The first wireless communication device of claim 1, wherein the one or more processors are individually or collectively further operable to execute the code to cause the first wireless communication device to:
receive, from the second wireless communication device, an indication of a quantity of antenna elements of the first wireless communication device to use for the adaptive uplink beam training, wherein transmission of the request is based at least in part on the indication of the quantity of antenna elements, and wherein the quantity of antenna elements is less than a total quantity of antenna elements available at the first wireless communication device.

5. The first wireless communication device of claim 1, wherein, to transmit the request, the one or more processors are individually or collectively operable to execute the code to cause the first wireless communication device to:
transmit an indication of a quantity of antenna elements of the first wireless communication device that the first wireless communication device is capable of using for the adaptive uplink beam training.

6. The first wireless communication device of claim 1, wherein the parameter for the millimeter wave communications comprises a quantity of antenna elements of the first wireless communication device, a quantity of antenna elements of the first wireless communication device, an uplink link budget, a quantity of radio frequency chains at the first wireless communication device, a quantity of radio frequency chains at the second wireless communication device, or a combination thereof.

7. The first wireless communication device of claim 1, wherein, to transmit the set of sounding reference signals, the one or more processors are individually or collectively operable to execute the code to cause the first wireless communication device to:
use, for at least a second subset of the set of sounding reference signals, a second set of beams via application of a set of codebook-based static beam weights to a second set of antenna elements of the first wireless communication device.

8. The first wireless communication device of claim 7, wherein the set of antenna elements of the first wireless communication device are a subset of the second set of antenna elements.

9. The first wireless communication device of claim 1, wherein:
the respective sets of adaptive beam weights comprise respective phase shift values.

10. The first wireless communication device of claim 1, wherein:
the first wireless communication device is a user equipment, and
the second wireless communication device is one of a network entity, a relay node, a repeater, or an integrated access and backhaul node.

11. The first wireless communication device of claim 1, wherein:
the first wireless communication device is one of a relay node, a repeater, a customer premises equipment, or an integrated access and backhaul node, and
the second wireless communication device is one of a network entity, a second relay node, a second repeater, or a second integrated access and backhaul node.

12. A method for wireless communications at a first wireless communication device, comprising:
transmitting, to a second wireless communication device, a request for a quantity of sounding reference signal opportunities to perform adaptive uplink beam training for millimeter wave communications between the first wireless communication device and the second wireless communication device, wherein the quantity of sounding reference signal opportunities is based at least in part on a parameter for the millimeter wave communications;
receiving, from the second wireless communication device, a grant for a set of sounding reference signal opportunities, wherein the set of sounding reference signal opportunities is based at least in part on the quantity requested by the first wireless communication device; and
transmitting a set of sounding reference signals via the set of sounding reference signal opportunities and using, for at least a subset of the set of sounding reference signals, a set of beams formed by application of respective sets of adaptive beam weights to a set of antenna elements of the first wireless communication device.

13. The method of claim 12, further comprising:
receiving, from the second wireless communication device and based at least in part on transmitting the set of sounding reference signals, an indication of a set of adaptive beam weights to apply to the set of antenna elements for an uplink communication.

14. The method of claim 13, further comprising:
performing the uplink communication via an application of the set of adaptive beam weights to apply to the set of antenna elements.

15. The method of claim 12, further comprising:
receiving, from the second wireless communication device, an indication of a quantity of antenna elements of the first wireless communication device to use for the adaptive uplink beam training, wherein transmission of the request is based at least in part on the indication of the quantity of antenna elements, and wherein the quantity of antenna elements is less than a total quantity of antenna elements available at the first wireless communication device.

16. The method of claim 12, wherein transmitting the request comprises:
transmitting an indication of a quantity of antenna elements of the first wireless communication device that the first wireless communication device is capable of using for the adaptive uplink beam training.

17. The method of claim 12, wherein the parameter for the millimeter wave communications comprises a quantity of antenna elements of the first wireless communication device, a quantity of antenna elements of the first wireless communication device, an uplink link budget, a quantity of radio frequency chains at the first wireless communication device, a quantity of radio frequency chains at the second wireless communication device, or a combination thereof.

18. The method of claim 12, wherein transmitting the set of sounding reference signals comprises:
using, for at least a second subset of the set of sounding reference signals, a second set of beams via application of a set of codebook-based static beam weights to a second set of antenna elements of the first wireless communication device.

19. The method of claim 18, wherein the set of antenna elements of the first wireless communication device are a subset of the second set of antenna elements.

20. A non-transitory computer-readable medium storing code for wireless communications at a first wireless communication device, the code comprising instructions executable by one or more processors to:
transmit, to a second wireless communication device, a request for a quantity of sounding reference signal opportunities to perform adaptive uplink beam training for millimeter wave communications between the first wireless communication device and the second wireless communication device, wherein the quantity of sounding reference signal opportunities is based at least in part on a parameter for the millimeter wave communications;
receive, from the second wireless communication device, a grant for a set of sounding reference signal opportunities, wherein the set of sounding reference signal opportunities is based at least in part on the quantity requested by the first wireless communication device; and
transmit a set of sounding reference signals via the set of sounding reference signal opportunities and using, for at least a subset of the set of sounding reference signals, a set of beams formed by application of respective sets of adaptive beam weights to a set of antenna elements of the first wireless communication device.
